(19) United States
(12) Patent Application Publication
(10) Pub. No.: US 2015/0302358 A1
(43) Pub. Date: Oct. 22, 2015

(54) METHOD AND APPARATUS FOR ENABLING A USER ASSERTION SERVICE FOR VISITORS TO WEB PAGES

(71) Applicant: Rohit CHANDRA, Sunnyvale, CA (US)

(72) Inventor: Rohit CHANDRA, Sunnyvale, CA (US)

(21) Appl. No.: 14/691,528

(22) Filed: Apr. 20, 2015

Related U.S. Application Data
(60) Provisional application No. 61/981,693, filed on Apr. 18, 2014.

(51) Int. Cl. G06Q 10/10; H04L 29/08

(52) U.S. Cl. CPC G06Q 10/1053; H04L 67/02; H04L 67/10

(57) ABSTRACT

A method and user interface object for invoking a user assertion service to operate with a web page are disclosed. Consistent with one embodiment of the invention, a web portal hosting a user assertion service enables an evaluator to include a user interface element on his requirement posting. An applicant can interact with the user interface object to assert his suitability for the requirement, by including a guarantee, and the evaluator can determine the suitability of the applicant's assertion. Consistent with one embodiment of the invention, a web portal enabling the user assertion service provides one or more web pages for configuring one or more user interface objects to be added respective to one or more requirements. Each user interface object is displayed with its associated snippet of code, making it simple for a web author to copy and paste the code into any web page, or internet connected application that he is creating or modifying. Once embedded, the code snippet displays a user interface object (e.g., button) which when pressed or selected, invokes a user assertion service. Alternatively, the user assertion service may be automatically invoked without requiring the selection of a button.

### RELATED APPLICATIONS

The present application claims the benefit of the filing date of U.S. Provisional Patent Application with Ser. No. 61/981,693, filed on Apr. 18, 2014, the contents of which are hereby incorporated into the present application.

### FIELD

The present invention relates generally to web-based user services. More particularly, the present invention relates to methods and systems that enable users to make assertions and have other users evaluate those assertions.

### BACKGROUND

An overwhelming number of users are contending to be suitable for a plethora of different tasks and activities. However despite the availability of a large number of tools, and methodologies there is still a lot of effort that goes into evaluating the contending users' assertions. The assertions need to be evaluated for quality, accuracy, consistency, applicability and suite of similar characteristics. Given the amount of effort that is required in this evaluation process, it leaves a lot to be desired when it comes to efficiencies in the system.

A wealth of tools and information is available on the Internet, and particularly that segment of the Internet referred to generally as the World Wide Web. However, despite a lot of innovation in web-based tools and methods, there is still no clear, easy or automated way for one user to evaluate another user's assertion without expending considerable amount of time, effort and energy. Perhaps even more frustrating is the lack of web-based tools to attach significant weight or importance to the asserting user's contention.

An example of a user's assertion might be their suitability for an open job that an employer or company is recruiting for.

Typically, when a position opens up at an employer, or a company: the hiring manager prepares a job description 110. The job description usually includes a list of desired skills, characteristics in the person to be hired into that role 112, and a list of responsibilities to be fulfilled 114 once the person gets hired.

The job description will often include some information about the company 116. This information is commonly added by someone working for the Human Resources Department. Often this is common for all jobs being posted by that employer. Along with this, there may be a slew of other information that the Job Description will have such as Required Educational Qualifications 118, years of experience 120, physical location that the new employee would be working at 122, a salary range 124, and other miscellaneous information 126.

Once this Job Description 110 has been collated and formulated it is ready to be advertised and shared with the outside world. At which point the hiring company may choose to run classified advertisements, post it on their own website, and promote it in a variety of different ways so as to be able to locate a person who has the matching skillset and is a suitable hire to fill that role.

Often times, recruiting companies are utilized by the hiring company to go and search for candidates with matching skill sets. To do this—the recruiters, sometimes also called sourcers, will try and find resumes in existing collections/databases of resumes. These recruiters routinely do not possess an understanding of what the job entails, and therefore what skills the person they are looking for must ideally possess—which is why they go back to the Job Description and do a best-guess match.

The industry as a whole recognized this shortcoming, and today numerous tools exist that allow recruiters to match key-words on candidate resumes with key-words on the Job Description and make selections.

More sophisticated and advanced tools are also in existence, some of which rely on Artificial Intelligence, to try and make a match between matching candidate profiles and the current Job Description. The quality of these candidate-job matching may be debatable, but that is not relevant for this document.

Typically recruiters have to read through a pool of candidate resumes and short-list potentially matching resumes. Once a recruiter gets a list of matching resumes: the recruiter now needs to ascertain if the candidate is available and/or looking for a new job. This involves the recruiter, sourcer, or a junior administrative person making first contact with the candidate: to determine availability, salary expectations, location desired—and more or less of other matching criterion. If there is a sufficient match, then a follow-up call is scheduled—typically with the recruiter, or a senior recruiter.

Thereafter a recruiter will typically have a conversation with the candidate to further qualify the candidacy. If the recruiter believes the candidate is qualified, then the resume gets forwarded onto the Hiring Manager.

The Hiring Manager in turn reviews a list of resumes from the recruiter and then selects a subset of those candidates to have a conversation/interview with.

This is a sieving/filtering process where a significant portion of candidates get disqualified, or are determined to be not suitable matches. Expending this energy causes significant cost to the recruiting entity—which could be the employer themselves, or it could be a recruiting company or such, or both!

Thus, there is a compelling need for a tool, a system, and a method to easily, quickly, and at a little, or no cost, identify matching candidates. Essentially we need an efficient method, or an efficient system that enables some users to make assertions and have other users evaluate those assertions, and potentially make business decisions based upon the validity/invalidity, or accuracy of those assertions.

### BRIEF DESCRIPTION OF THE DRAWINGS

The accompanying drawings, which are incorporated in and constitute a part of this specification, illustrate an implementation of the invention and, together with the description, serve to explain the advantages and principles of the invention. The other objects, features and advantages will occur to those skilled in the art from the following description and the accompanying drawings in which:

FIGS. 1 and 2 illustrate an schematic flowchart illustrating a method for enabling a user assertion service for visitors to web pages, according to an embodiment of the invention;

FIG. 3 is a schematic network architecture illustrating a system for evaluating user assertions, according to an embodiment of the present disclosure;

FIG. 4 is an exemplary block diagram for a job description requirements, according to an embodiment of the present disclosure, and

FIG. 5 through 7 illustrate examples of a generated snippet of code, with options for some customizations, according to an embodiment of the invention; and

FIG. 8 through 11 illustrate examples of content server pages with user interface objects to enable invoking a user assertion service, according to an embodiment of the invention.

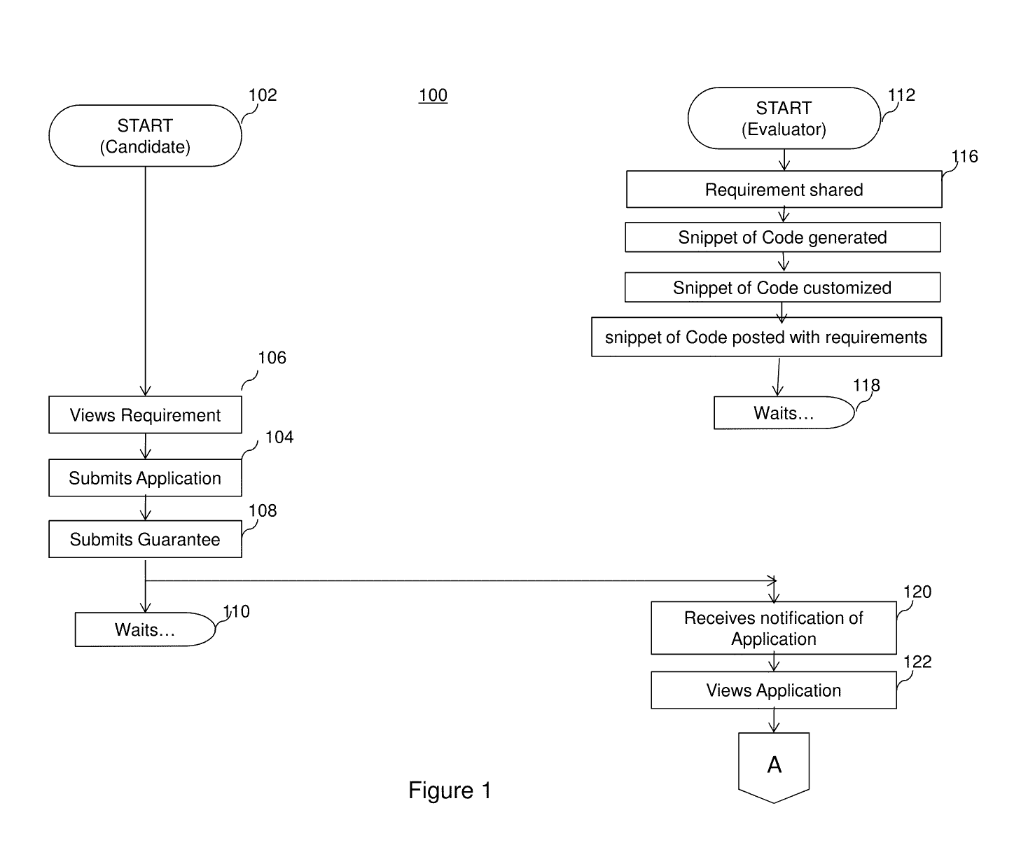

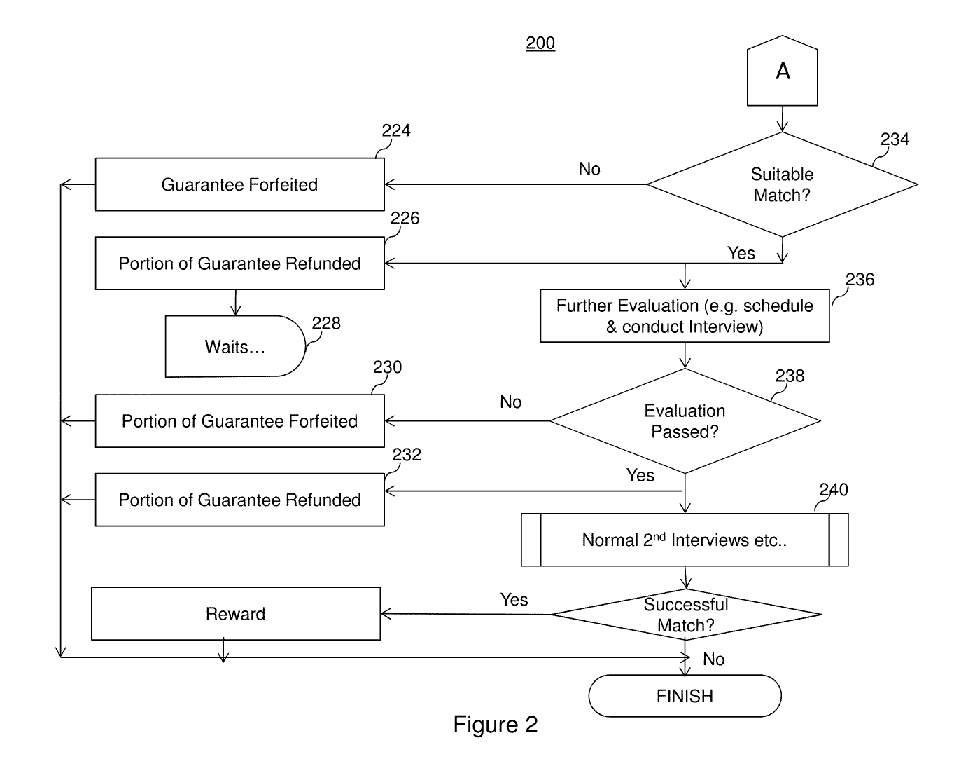

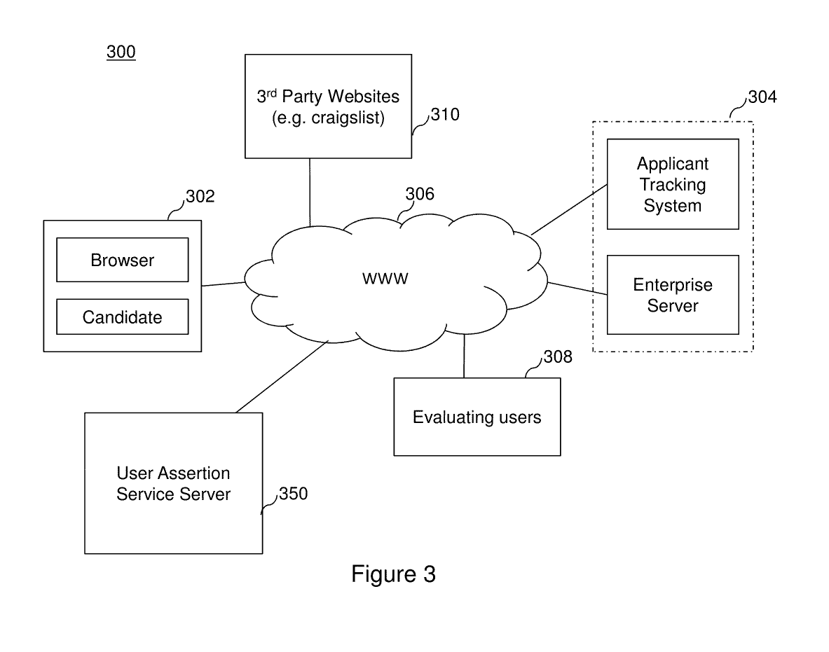

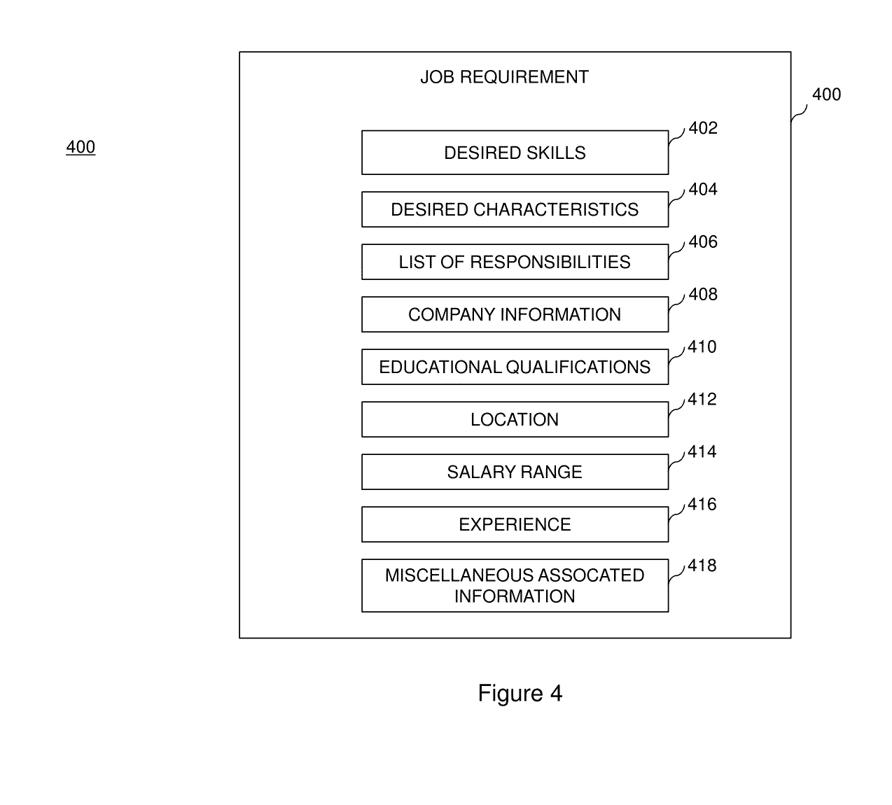

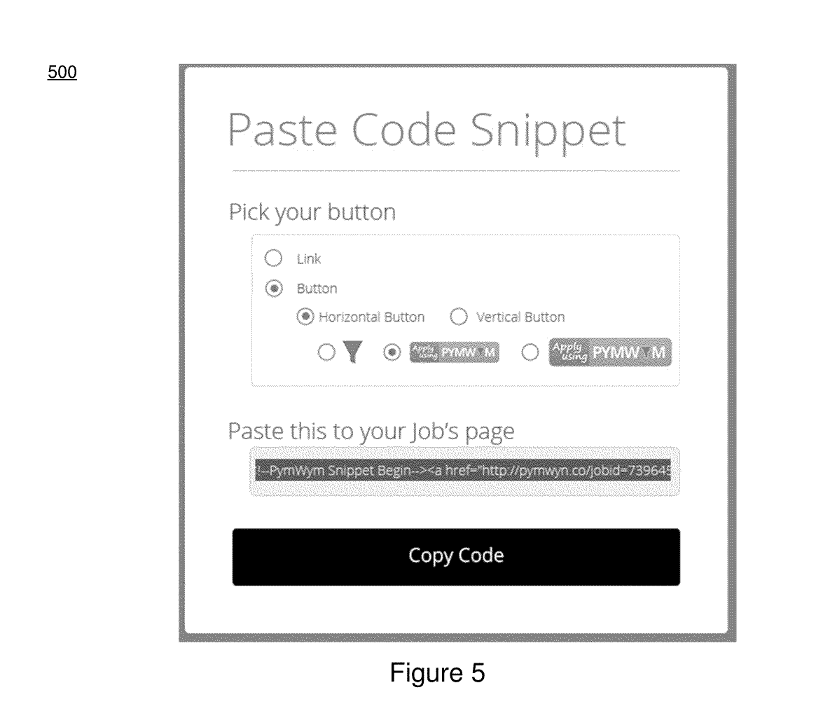

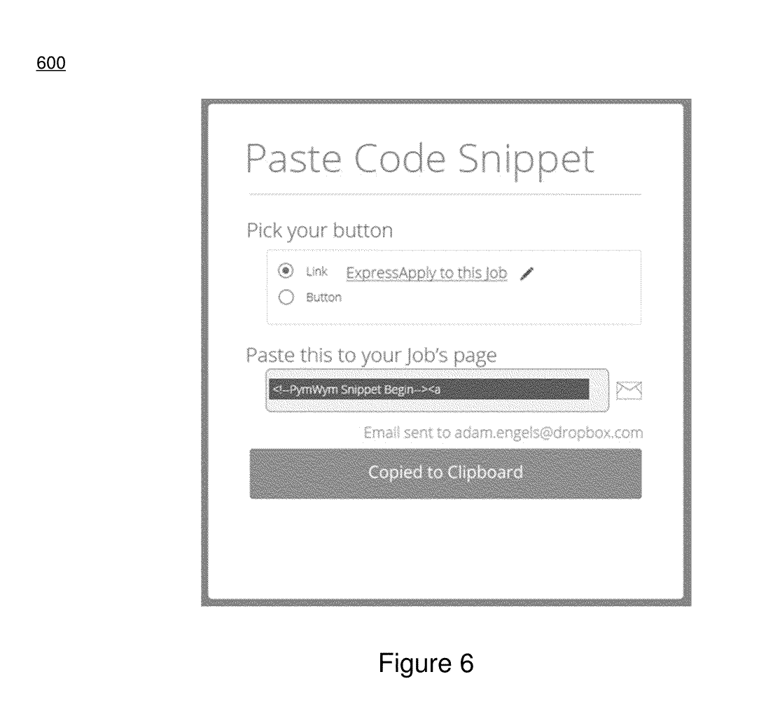

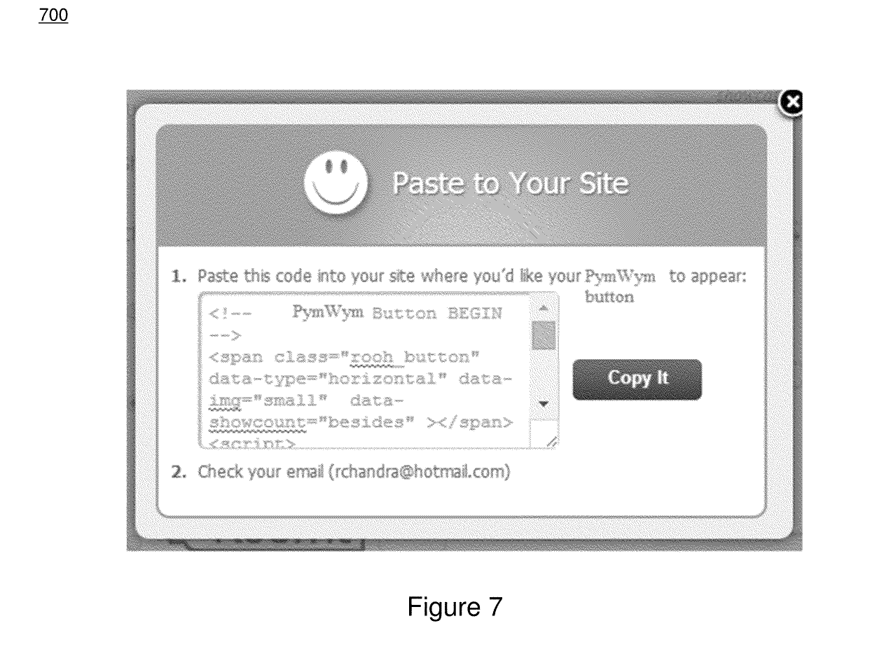

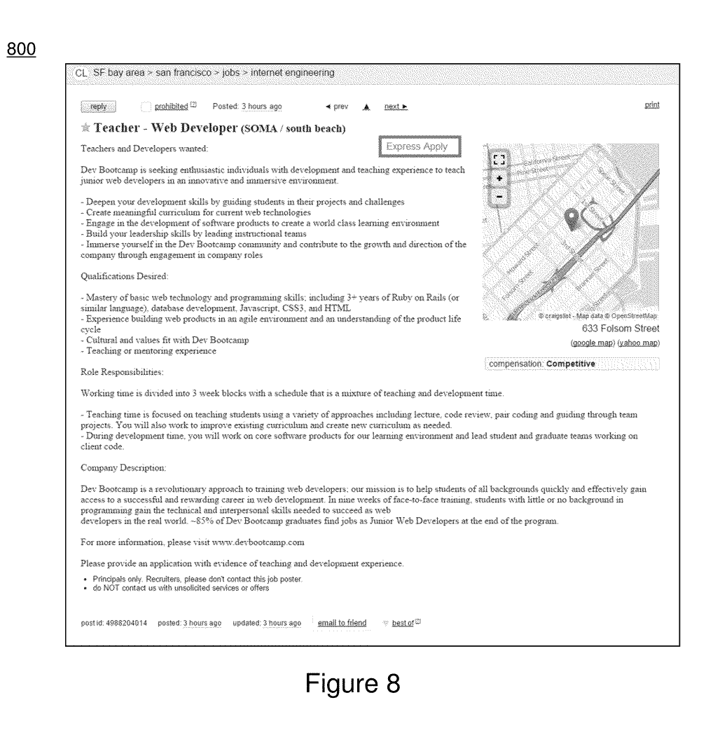

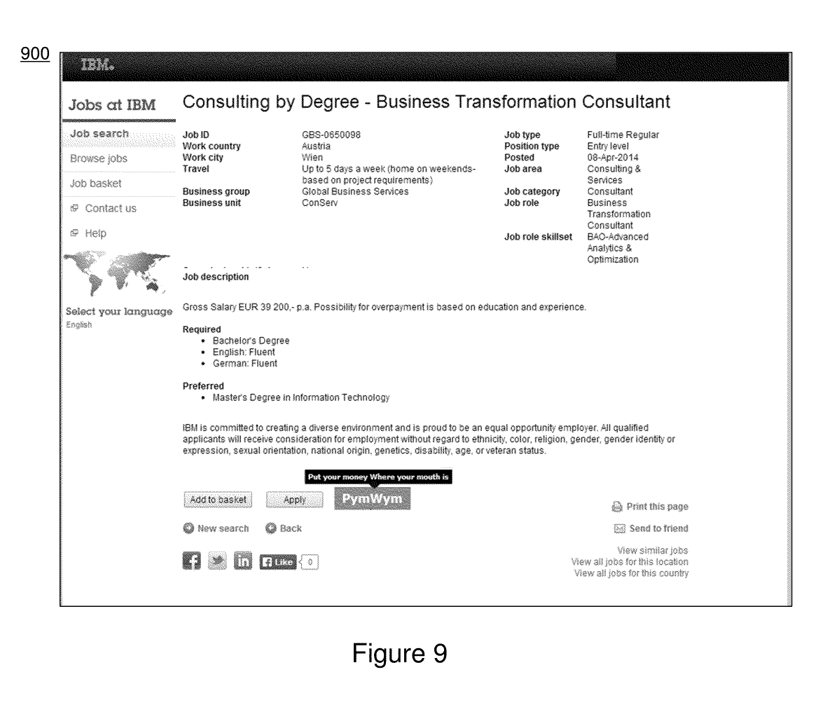

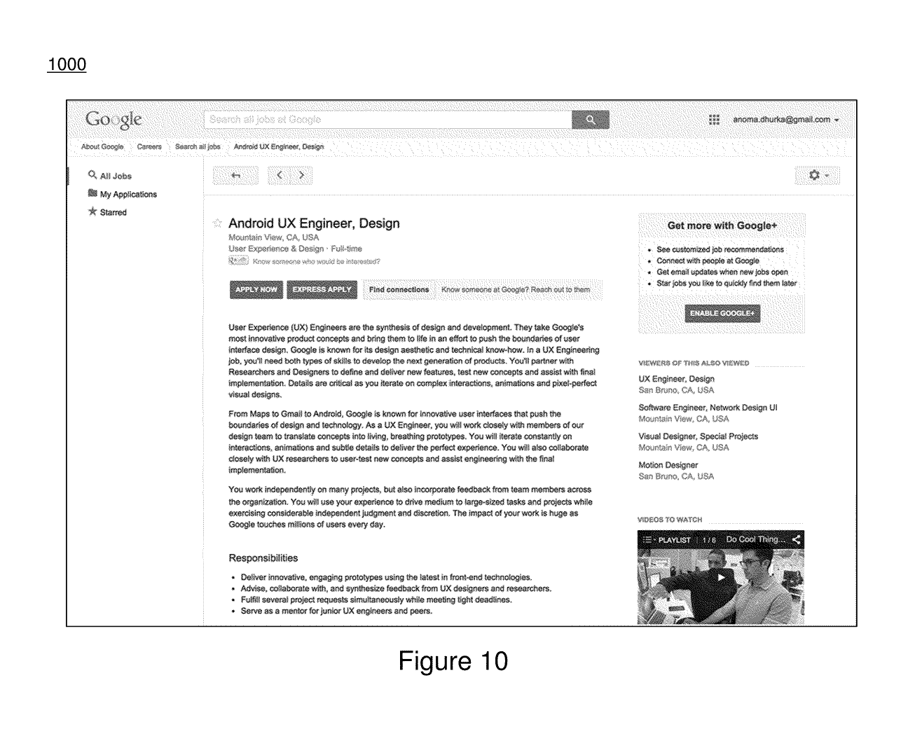

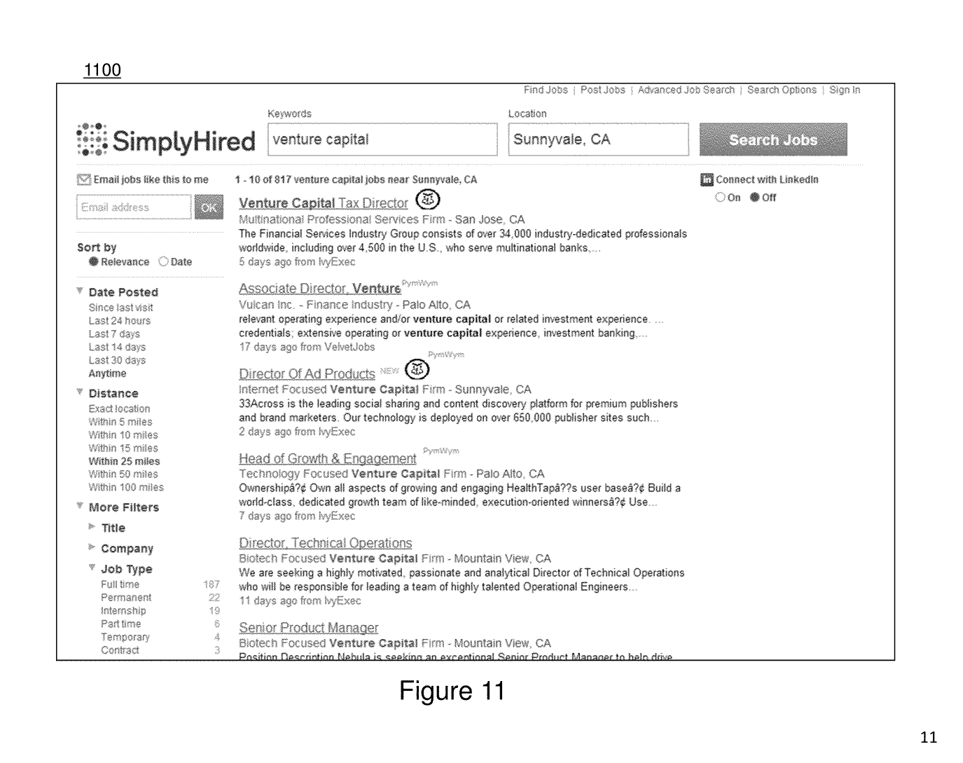

### SUMMARY

A method for invoking a user assertion service to operate with a web page, internet connected application or similar are disclosed. According to one embodiment of the invention, a content provider server serves an internet document including a user interface object to a client web application. The internet document enables a user to invoke the user assertion service by interacting with it (e.g., by selecting or traversing the user interface object). In another embodiment of the invention, a server hosting the user assertion service includes a web page, providing users of the user assertion service access to various features of the user assertion service. The web page serves an internet document including a snippet of code that can be inserted into a content provider's internet document or web page by simply copying and pasting the code snippet. For example, in one embodiment, the code snippet represents a user interface object with associated code. When the content provider serves the internet document including the code snippet, the user interface object is displayed. When a user interacts with the user interface button (e.g., by selecting it), a user assertion service hosted by the user assertion server is invoked, thereby enabling the user to make an assertion of his suitability for a requirement. An asserting user may have the ability to submit an application and to provide a guarantee, or a penalty structure for failed, or disqualified/invalidated assertions. Other evaluating users then have the ability to evaluate the assertions for validity, quality, and accuracy. Evaluating users have the ability to apply penalties and forfeitures on the guarantee. Similarly upon successful matches, applicants and participating entities, including the operator of the assertion service may be rewarded. Users participating in the assertion system may have the opportunity to rate other involved entities.

Other aspects of the invention are described below in connection with the description of the figures.

### DETAILED DESCRIPTION

### Glossary

Requirement: an identified need.

Posting: a description of a requirement.

Assertion: is a claim of suitability for a requirement.

Candidate: an entity (or their representative) considering their suitability for a requirement.

Guarantee: a surety placed to support the candidate's assertion of suitability.

Applicant: a candidate (or their representative) who has asserted their suitability for a requirement.

Evaluator: is an entity (or their representative) that determines the suitability of an assertion.

Employer: an entity (or their representative) with an open requirement. Employer is an instance of an evaluator.

Hiring Manager: is an exemplary instance of an evaluator.

User assertion service: is a service that enables an applicant's assertion to be evaluated, by an evaluator, in the context of a requirement, to help determine suitability match utilizing a guarantee mechanism.

Recruiting service: an example of a user assertion service.

Reward: is typically a financial pay-out paid to the recruiting service, the applicant, the evaluator, and/or their representatives—in any combination—for a successful matching outcome.

Reference will now be made in detail to an implementation consistent with the present invention as illustrated in the accompanying drawings. Wherever possible, the same reference numbers will be used throughout the drawings and the following description to refer to the same or like parts. Although discussed with reference to these illustrations, the present invention is not limited to the implementations illustrated therein. Hence, the reader should regard these illustrations merely as examples of embodiments of the present invention, the full scope of which is measured only in terms of the claims following this description. In particular, many of the various aspects and features of the invention are most easily understood by those skilled in the art. Further, those skilled in the art will appreciate that the features, and user interface elements illustrated and described are examples, and the invention is not to be limited by those user interface elements, and features specifically illustrated in the drawings.

The various embodiments herein disclose a method and system for enabling a candidate to make an assertion and have an evaluator evaluate the assertion. In the following detailed description of the embodiments of the invention, reference is made to the accompanying drawings that form a part hereof, and in which are shown by way of illustration specific embodiments in which the invention may be practised. These embodiments are described in sufficient detail to enable those skilled in the art to practise the invention, and it is to be understood that other embodiments may be utilized and that changes may be made without departing from the scope of the present invention. The following detailed description is, therefore, not to be taken in a limiting sense, and the scope of the present invention is defined only by the appended claims.

The specification may refer to “an”, “one” or “some” embodiment(s) in several locations. This does not necessarily imply that each such reference is to the same embodiment(s), or that the feature only applies to a single embodiment. Single features of different embodiments may also be combined to provide other embodiments.

As used herein, the singular forms “a”, “an” and “the” are intended to include the plural forms as well, unless expressly stated otherwise. It will be further understood that the terms “includes”, “comprises”, “including” and/or “comprising” when used in this specification, specify the presence of stated features, integers, steps, operations, elements and/or components, but do not preclude the presence or addition of one or more other features, integers, steps, operations, elements, components, and/or groups thereof. As used herein, the term “and/or” includes any and all combinations and arrangements of one or more of the associated listed items.

Unless otherwise defined, all terms (including technical and scientific terms) used herein have the same meaning as commonly understood by one of ordinary skill in the art to which this disclosure pertains. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Described herein are various aspects related to a candidate making an assertion with regard to his suitability for a requirement, and have an evaluator evaluate that assertion. The present invention describes effective methods for applying for a requirement, along with a guarantee, forwarding the application, or a representation of the application, to an evaluator, and determining a suitability match.

In one embodiment of the invention, a recruiting service is provided by a cloud based user assertion service. Consistent with an embodiment of the invention, the recruiting service enables employers, or their representatives to post open job requirements. The set of job requirements could be a detailed job description or something as simple as “Software Engineer needed.” It will be obvious to one ordinarily skilled in the art that the job requirements can be posted by someone on behalf of the employer, and could potentially even be posted by a third-party recruiter, headhunter, agency, or a representative thereof: none of which would deviate from the spirit or scope of the invention.

In other alternate embodiments of the invention, the requirement could be as simple as “Date needed”, “Looking for future wife”, “funding sought”, “Guitarist required”, “Searching for Publisher”. The foregoing examples of various implementations of the invention have been presented for purposes of illustration and description. They are not exhaustive and do not limit the invention to the precise form or forms disclosed. It will be appreciated by those skilled in the art that the present invention may find practical application in a variety of alternative contexts that have not explicitly been addressed herein.

In other alternate embodiments, the recruiting service has the ability to fetch job requirements from other locations on the Internet, scrape open job requirements from other websites, or get them from sources. In another alternate embodiment the requirements may not even be posted anywhere on the Internet, yet the evaluation service could be used to determine suitability matching of asserting users. In fact, the afore mentioned list is merely an example and not intended to limit the set of methods and mechanisms by which the requirements may be posted.

In one embodiment of the invention, once the job requirements have been posted, the employer, or their representative are presented with a series of options to select from. The options enable the employer, or their representative: to customize the appearance and behavior of the user assertion service. These settings control how the user assertion service behaves in each individual instance.

In one embodiment of the invention, employers would be able to customize a user-interface object such as to select: a hyperlink, button, or image. The ability to pick, or specify the size and orientation of the image. The text or visual display to be presented. The colors. The action, or set of actions to be performed when a user interacts with the user-interface object. Again, the above list is not intended to limit the scope of the invention, but is merely presented for the purposes of illustration. Those ordinarily skilled in the art would appreciate a plethora of additional option settings that could be presented, and the related functionalities that could be controlled by the customizations made by the employer, and their representative.

In one embodiment of the invention, the customizations made by employers could affect and dictate the very behavior of the user assertion service, the evaluation mechanism, the response mechanism, the reward mechanism and/or numerous other options. Those ordinarily skilled in the art would appreciate a plethora of additional options that could be presented, and the related functionalities that could be controlled by the customizations made by the employer, and their representative.

Consistent with an embodiment of the invention, employers would then be availed a snippet of code with zero or more parameters that will control the behavior of the user assertion service when invoked in the context of their requirement. The snippet of code could be presented to employers on a web page, sent via email, SMS, text message, WhatsApp, Skype, or any other communication mechanism.

In an alternate embodiment, the code could directly be manipulated inside the employer's own website, such as a web page hosted to display that requirement.

In other embodiments, employers could embed the code and share their requirement on third party internet websites such as craigslist.org, simplyhired.com, indeed.com, monster.com, glassdoor.com, dice.com. or any number of other websites. The advantages to an employer being that potential applicants could interact with the user interface object on those other websites, and still be able to utilize the user assertion service to assert their suitability.

In one embodiment of the invention that application could be a resume, in another a cover letter, in yet another a personal bio-data. Again, the above examples are not intended to limit the scope of the invention, but are merely presented for the purposes of illustration. Those ordinarily skilled in the art would appreciate a multitude of variations that would not deviate from the spirit or scope of the invention.

In an embodiment of the invention, customizations and subsequent changes to employer selected options could transparently be affected to locations where that requirement is already posted without requiring any modification or updates to the code itself.

Consistent with one embodiment of the invention, pasting the code inside a web page, or an internet connected application causes a user-interface object to be displayed. Examples of the user interface object could be a hyperlink that reads “Express Apply”, “Apply for Software Engineer”, “Apply Now” etc. The user interface object could be a web button, or could be an image. It could be embedded somewhere inside the requirements posting, or it could be on the side, of the posting, at the top of the posting, at the bottom, always visible, or any of a multitude of presentations including situations when it is present without the requirements: all of which would be within the scope and spirit of the present invention.

Consistent with one embodiment of the invention, a recruiting service is provided by a cloud based service, which enables a candidate to interact with an internet connected application such as, but not limited to, a web browser application. The candidate would be able to view the contents of an internet document describing an open requirement.

In an embodiment of the present invention, there could be displayed a set of ratings associated with a requirement. The ratings could be algorithmically determined by factoring in a weighted plurality of factors such as responsiveness, hiring ratio, past applicant inputs, accuracy, forfeit percentage, company reputation, hiring manager reputation and like. In an embodiment of the present invention, the rating can be made visible to all the users who visit the web page containing the job requirement post.

In an embodiment of the present invention, the candidate can make a determination of (i) his suitability for the requirement, and (ii) based upon the requirement's rating, candidate's desirability to apply. Should he choose to, candidate can manipulate a user interface object of his web application to assert his suitability for the requirement by submitting an application. The user interface object could just as easily be present on an internet connected application such as a mobile app. or similar. Furthermore, a candidate does not necessarily need to view an open requirement in order to apply for it, he can just as easily use a set of unique identifiers in order to apply for a specific requirement. It will be obvious to those ordinarily skilled in the art that having the user interface object comprised in an application not specified in this description would not deviate from the spirit or scope of the invention.

The recruiting service has the ability to store the application submitted by the candidate. In some embodiments, the service may alternatively, or additionally, choose to share a copy of the application, or a representation of the application, with one or more other evaluators (aka evaluating users) using some notification mechanism such as email, instant message, SMS, phone, skype, VOIP, WhatsApp, alert, or similar. The evaluator may be an employee, or a representative of: the potential employer, the evaluation service, a third-party recruiter, a computer program or any entity with the skills to evaluate an application for suitability match. Those skilled in the art will recognize that an evaluator different from the listed varieties does not deviate from the scope or spirit of the invention.

The cloud based system hosting the recruiting service has the ability to offer a set of—one or more user interface objects that the candidate can manipulate to specify, or select from a pre-determined list, a guarantee he is offering to prove his assertion: in this embodiment, of his suitability for the job. The guarantee being offered up by the candidate could be monetary, in-kind, or some other acceptable commodity, service or the ilk such as bitcoin, loyalty program rewards, points, or similar. The candidate's guarantee is stored by the recruiting service. In one embodiment of the invention, the notification to the evaluator is not sent until the guarantee has been successfully secured. In another embodiment, the guarantee is collected and stored by the user assertion service. Similarly the guarantee could potentially be collected upfront.

Once the guarantee is in place a recruiter, hiring manager or evaluator is notified of the applicant's assertion. The evaluator can choose to receive such notifications on their email, phone, internet connected device, etc. or, they could choose to periodically visit a web page to view notifications directed to them. One ordinarily skilled in the art, will appreciate any number of a different notification mechanisms could be utilized to present the candidate's application credentials for evaluation.

The evaluator then has the ability to determine the quality of the match. In one embodiment of the invention, if the evaluator determines that there is no match, then the entire portion of the guarantee may be subject to forfeiture.

Alternatively, the evaluator may see a potential match in which case a portion (say half) of the guarantee would be immediately available for refund to the candidate. The remainder of the guarantee would continue to be held until the evaluator has had the opportunity to conduct an interview. One ordinarily skilled in the art would recognize that an interview could really be a telephonic conversation, an in person meeting, a virtual meeting like WebEx, Skype or some other kind of interaction.

Post interview, the evaluator makes a determination about the accuracy, quality, validity, etc. of the assertion. In one scenario: if the evaluator wishes to further interview the candidate he may refund the entire remainder guarantee; or he may choose to not further interview and yet refund the entire remainder of the guarantee; or he may choose to forfeit the entire remaining guarantee and not interview the candidate further. These are just exemplary outcomes, a reader ordinarily skilled in the art could establish numerous other outcomes—none of which would deviate from the spirit or scope of the invention.

The recruiting service enables the evaluator to manipulate user interface objects in his browser to make selections. The selections presented by the recruiting service enable the evaluator to specify, or select, what portion of the candidate's remaining guarantee should be forfeited. In one embodiment of the invention, these selections are then stored by the recruiting system and the user assertion service facilitates refunds of the non-forfeited portion of the guarantee back to the candidate.

In case of a successful match, the candidate, the evaluator, the operator of the user assertion service, any of their representatives, or some combination of the lot may be rewarded for contributing towards making a successful match.

In an embodiment of the present invention, an applicant who has submitted an application, the evaluator of his application, the respective entities that the applicant and evaluator represent, and the operator of the user assertion service—or some combination of any of them—may have the opportunity to rate the other involved entities. Historical aggregation of such ratings result in creating reputations for each entity which may be utilized to algorithmically assign ratings for their future.

Advantageously, the present invention provides an efficient way of placing a user interface object on a requirement posting to enable the invocation of a user assertion service. Wherein such a service enables the applicant to assert his suitability, accompanied by a guarantee, with respect to a particular requirement. By virtue of the method and system of applying, making a guarantee, and evaluating the applicant's assertion, candidates are more selective and industrious when submitting an application. Therefore attracting a higher quality of applicants. As an outcome of better quality applicants, the burden on the evaluator in pursuing unsuitable, irrelevant, and dud applications may be reduced. Also reputations are constructively built for applicants and evaluators alike, resulting in an increased sense of accountability. Further, the guarantee amount, or a portion of it may be forfeited based on the suitability matching of the candidate's application. And the candidate may even be rewarded for a successful suitability match.

Although the present invention is described herein in many instances in the context of a recruiting service, those skilled in the art will recognize a wide variety of other applications that are consistent with the general spirit and scope of the invention. Such a system can be implemented for any kind of a supply-demand system, or a system where one entity seeks an audience or interaction with another entity. For instance, consistent with another embodiment of the invention: it could be applied to qualify aspiring musicians, aspiring actors, entrepreneurs seeking funding, business development leads, dating, matchmaking, or a plethora of other activities—none of which would deviate from the spirit of the current invention.

The present embodiments have been described with reference to specific example embodiments; it will be evident that various modifications and changes may be made to these embodiments without departing from the broader spirit and scope of the various embodiments. Furthermore, the various devices, modules, and the like described herein may be enabled and operated using hardware circuitry, for example, complementary metal oxide semiconductor based logic circuitry, firmware, software and/or any combination of hardware, firmware, and/or software embodied in a machine readable medium.

Although the embodiments herein are described with various specific embodiments, it will be obvious for a person skilled in the art to practice the invention with modifications. However, all such modifications are deemed to be within the scope of the claims. It is also to be understood that the following claims are intended to cover all of the generic and specific features of the embodiments described herein and all the statements of the scope of the embodiments which as a matter of language might be said to fall there between.

It will be appreciated by those skilled in the art that various architectures may be used to implement an assertion service consistent with the invention described herein. Furthermore, although many functions described herein are attributed to either a client or a server, those skilled in the art will appreciate that in alternative embodiments of the invention, a function attributed herein to a server, may in fact be implemented on, or provided by a client device. Similarly, a function described herein as being provided by a client, may be provided by a server in an alternative embodiment of the invention. The cloud based system presented is just one embodiment of the invention. In an alternative embodiment, such a system could be developed as a stand-alone solution, a client-server solution, another cloud based system where the enterprise hosting the user evaluation service and the employer enterprise are one and the same, or a number of other implementations without deviating from the spirit of the invention. Other aspects of the invention will become apparent from the descriptions of the drawings that follow.

The foregoing description of various implementations of the invention has been presented for purposes of illustration and description. It is not exhaustive and does not limit the invention to the precise form or forms disclosed. Furthermore, it will be appreciated by those skilled in the art that the present invention may find practical application in a variety of alternative contexts that have not explicitly been addressed herein. Finally, the illustrative processing steps performed by a computer-implemented program (e.g., instructions) may be executed simultaneously, or in a different order than described above, and additional processing steps may be incorporated. The invention may be implemented in hardware, software, or a combination thereof. When implemented partly in software, the invention may be embodied as a set of instructions stored on a computer-readable medium. The scope of the invention is defined by the claims and their equivalents.

What is claimed is:

1. A computer-implemented method for evaluating an applicant's assertion of suitability, the method comprising:
serving an internet document to a candidate's internet connected application,
wherein the internet document includes code that invokes a user assertion service to interact with the candidate, and
wherein the user assertion service enables the candidate to apply for a requirement, and
wherein the user assertion service enables the candidate to submit a guarantee, and
wherein the user assertion service enables an evaluator to receive a notification respective of the application, and
wherein the evaluator makes a determination of matching suitability of the application with respect to the requirement.

2. The computer-implemented method of claim 1, wherein a portion of the code is associated with a user interface object, and
wherein the user interface object is a graphic, text, hyperlink, or widget; and
only when a user interacts with said user interface object does the code invoke the user assertion service.

3. The computer-implemented method of claim 1,
wherein the user assertion service is hosted by a server other than a server hosting the internet document.

4. The computer-implemented method of claim 1, wherein
the code that invokes a user assertion service is generated, and
the code that invokes a user assertion service is provided via a web page; and
the code that invokes a user assertion service can be customized via the same or another web page to specify one or more options that determine another one or more settings of the user assertion service when invoked.

5. The computer-implemented method of claim 1, wherein the code to invoke the user assertion service is added automatically to a content provider's web page using at least one of a computer program, and an application programming interface.

6. The computer-implemented method of claim 1, wherein the user assertion service makes a determination of suitability match respective to the requirement, when it receives an application submitted by an applicant.

7. The computer-implemented method of claim 1, wherein the user assertion service enables at least one of the applicant, the evaluator, and the operator of the user assertion service to be rewarded for a successful match.

8. The computer-implemented method of claim 1, wherein the code invokes the user assertion service by causing the client web browser to communicate a request to a user assertion service agent executing on a server which is not controlled by an enterprise hosting the user assertion service, and said agent communicates a separate request to a server hosting the user assertion service.

9. A system useful in evaluating applicant's assertion regarding his suitability for a posted requirement, the system comprising executing on a processor the steps of:
a web server module for serving an internet document to a client web browser, wherein the internet document includes code to invoke a user assertion service; and
a user assertion service agent to receive messages from the client web browser, wherein said agent relays the messages to a user assertion service hosted on a user assertion server.

10. The system of claim 9, wherein a portion of the code is associated with a user interface object, and
wherein the user interface object is a graphic, text, hyperlink, or widget; and
only when a user interacts with said user interface object does the code invoke the user assertion service.

11. The system of claim 9, wherein the user assertion service, when invoked,
enables a user to make an assertion regarding his suitability for a requirement referenced by the current internet document, and
enables the candidate to submit a guarantee, and
enables an evaluator to receive a notification respective of the application, and
enables the evaluator to make a determination of matching suitability of the application with respect to the requirement.

12. The system of claim 9, wherein the code to invoke a user assertion service includes one or more configuration settings that determine one or more settings of the user assertion service.

13. The system of claim 9, wherein the code to invoke a user assertion service is generated by a server hosting the user assertion service and is provided via a web page, and can be customized via parameters also selected via the same or another web page.

14. The system of claim 9, wherein the user assertion service enables at least one of the applicant, the evaluator, and the operator of the user assertion service to be rewarded for a successful match.

15. A non-transitory computer-readable medium for evaluating an applicant's assertion of suitability matching, comprising instructions stored thereon, that when executed on a processor, perform the steps of:
serving an internet document to a candidate's internet connected application,
wherein the internet document includes code that invokes a user assertion service to interact with the candidate, and
wherein the user assertion service enables the candidate to apply for a requirement, and
wherein the user assertion service enables the candidate to submit a guarantee, and
wherein the user assertion service enables an evaluator to receive a notification respective of the application, and
wherein the evaluator makes a determination of matching suitability of the application with respect to the requirement.

16. The computer-readable medium of claim 15, wherein a portion of the included code is associated with a user interface object, and
wherein the user interface object is a graphic, text, hyperlink, or widget; and
only when a user interacts with said user interface object does the code invoke the user assertion service.

17. The computer-readable medium of claim 15,
wherein the user assertion service is hosted by a server other than a server hosting the internet document.

18. The computer-readable medium of claim 15, wherein
the included code that invokes a user assertion service is generated, and
the included code that invokes a user assertion service is provided via a web page; and
the included code that invokes a user assertion service can be customized via the same or another web page to control one or more options that determine another one or more settings of the user assertion service when invoked.

19. The computer-readable medium of claim 15, wherein the code to invoke the user assertion service is inserted automatically to a content provider's web page using at least one of a computer program, and an application programming interface.

20. The computer-readable medium of claim 15, wherein the user assertion service enables at least one of the applicant, the evaluator, and the operator of the user assertion service to be rewarded for a successful match.
